(19) United States
(12) Patent Application Publication
(10) Pub. No.: US 2026/0266099 A1
(43) Pub. Date: Sep. 10, 2026

(54) RIGID CUFFS AND METHODS FOR USING THEM

(71) Applicant: FALCON (W.F.) TECHNOLOGIES LTD., Yavne (IL)

(72) Inventors: Dor ATIA, Beer Gannim (IL); Haim FRIED, Nizzan (IL)

(73) Assignee: FALCON (W.F.) TECHNOLOGIES LTD., Yavne (IL)

(21) Appl. No.: 19/556,113

(22) Filed: Mar. 4, 2026

(30) Foreign Application Priority Data
Mar. 5, 2025 (IL) 319418

(51) Int. Cl. E05B 75/00

(52) U.S. Cl. CPC E05B 75/00

(57) ABSTRACT

A cuffing system, comprising a first cuff member and a second cuff member; the first cuff member comprises a first cuff; the second cuff member comprises a second cuff; a cable regulator configured to regulate rolling and unrolling of a cable, said cable regulator is connected to at least one of the first cuff member and the second cuff member, said cable regulator comprising: a body; a pulley connected to a proximal end of the cable, said pulley rolls in a first direction when the cable is released and rolls in a second direction when the cable is folded; wherein an external surface of the pulley comprises teeth; a ratchet locker coupled to the body and being in physical contact with the teeth when the pulley rolls; a movable blocker coupled to the body or to the second cuff member, said movable blocker having a first position blocking presence of a person's hand in the second cuff when the second cuff is closed and a second position that moves the ratchet locker towards the teeth; wherein the second position limits the pulley to roll in the second direction only; a movable member moving in the body and configured to prevent movement of the ratchet locker away from the teeth.

### RELATED APPLICATION

The present application claims benefit from prior Israel Patent Application 319418, filed on Mar. 5, 2025, which is incorporated by reference herein in its entirety.

### FIELD OF THE INVENTION

The subject matter generally relates to rigid cuffs.

### BACKGROUND OF THE INVENTION

A rigid cuff typically refers to a type of restraint device used in law enforcement or medical settings. It is a rigid structure, often made of metal or hard plastic, that is designed to be secured around a person's wrist or ankle to restrict movement. Rigid cuffs are commonly used as part of handcuffs or leg irons to restrain individuals who pose a risk to themselves or others, such as suspects being arrested or patients in medical facilities.

The term “rigid” implies that the cuff does not have flexibility or give, meaning once secured, the cuff maintains its shape and structure without easily bending or deforming. This design feature helps ensure that the individual remains securely restrained and prevents them from tampering with or removing the restraints.

Rigid cuffs are often equipped with locking mechanisms to prevent them from being opened without the appropriate key or tool. They are an essential tool for law enforcement officers, security personnel, and medical professionals when managing potentially dangerous or disruptive individuals while maintaining safety and control.

### SUMMARY OF THE INVENTION

The subject matter discloses a cuffing system, comprising a first cuff member and a second cuff member; the first cuff member comprises a first cuff and a receiver configured to receive a connector coupled to the first cuff member; the second cuff member comprises the connector; a second cuff; a cable housing coupled to the second cuff, said cable housing is configured to contain a cable; a cable regulator configured to enable rolling and unrolling of the cable.

In some cases, the connector is connected to the cable, such that a distance between the first cuff and the second cuff is extended when the cable is released.

In some cases, the cable regulator further comprises a pulley configured to roll when the cable is released.

In some cases, the second cuff further comprises a lock slider movable from a first position to a second position, wherein the a shackle of a circular shape and a lock configured to be secured to the shackle to lock the second cuff; wherein the lock has an external surface configured to interface with an internal surface of the lock slider when the lock slides onto the shackle.

In some cases, the second cuff further comprises a key house configured to accommodate a key configured to open the cuff, wherein the key house is located close to the lock slider such that movement of the key moves the lock slider.

In some cases, the cuffing system further comprises a ratchet locker coupled to the locker slider such that the ratchet locker moves in response to movement of the lock; wherein the ratchet locker has a first position enabling release of the cable and a second position disabling release of the cable.

In some cases, the ratchet locker further comprises ratchet teeth configured to interface with the cable housing. In some cases, the cuffing system further comprises a locking pin configured to prevent movement of the ratchet locker and the locker slider. In some cases, the cable housing is removable from the second cuff member.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a pair of rigid cuffs connected by a releasable cable, according to exemplary embodiments of the invention.

FIG. 2 shows a cable housing, a cable, and a pin coupled to the distal end of the cable, according to exemplary embodiments of the invention.

FIG. 3 shows the first cuff distant from the second cuff, connected via cable, according to exemplary embodiments of the subject matter.

FIGS. 4A-4D show the cuff device in various positions, according to exemplary embodiments of the subject matter.

FIG. 5 shows a method of using a cuff device, according to exemplary embodiments of the subject matter.

FIGS. 6A-6B show a second cuff member having a movable blocker, according to exemplary embodiments of the subject matter.

### DETAILED DESCRIPTION

Rigid cuffs are used to cuff prisoners or suspects of crimes and breaches of order. A police officer or law enforcement person has to hold the cuffed person, cuff the person in a first arm, then bring the other arm close to the first arm and cuff the second arm. When the cuffed person resists, the cuffed person may be injured, when the most frequent injuries involve the cuffed person's arms and shoulders. In addition, the law enforcement person has to apply more force and spend more time in bringing the cuffed person's arm towards the cuff.

The device and methods disclosed herein overcome the disadvantages of known cuffs by providing a cuff system having two cuffs, a cable connecting the two cuffs, and a control mechanism configured to control the cable's expansion. This way, the law enforcement person can bring the other cuff towards the cuffed person's other arm instead of forcing the cuffed person to bring his/her arm towards the second cuff, after cuffing the first arm.

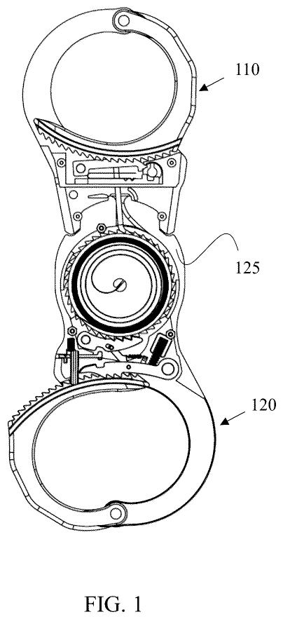

FIG. 1 shows a pair of rigid cuffs connected by a releasable cable, according to exemplary embodiments of the invention. The device of the subject matter comprises a first cuff 110, a second cuff 120, and a regulating mechanism 125 that stores a cable and regulates the release of the cable. The first cuff 110 comprises an interface for receiving a connector coupled to a distal end of the cable. The connector may be an elongated pin, a cylindrical pin, may be of an elliptical or polygonal cross-section, or may be of any design desired by a person skilled in the art. The interface of the first cuff 110 may comprise movable parts, for example, a piston, a knob, or a spring configured to lock the connector in response to an event, for example in case the connector reaches a certain proximity to the first cuff 110, for example, less than 5 centimeters.

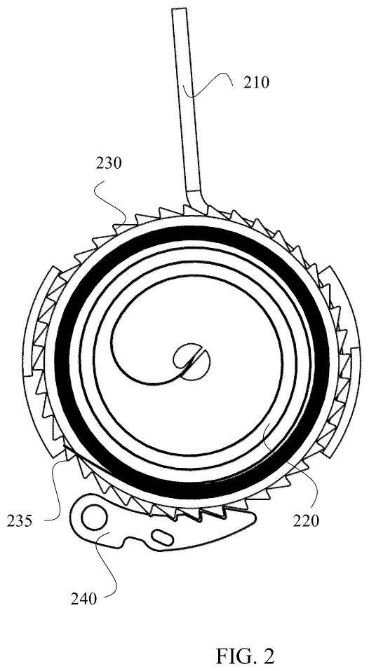

FIG. 2 shows a cable housing, a cable, and a pin coupled to the distal end of the cable, according to exemplary embodiments of the invention. The cable 220 is rolled inside the cable housing 230 to allow quick release of the cable 220 when it is required to move one cuff away from the other cuff and to quickly collapse the cable 220 back into the cable housing 230. The cable housing 230 may comprise an aperture (not shown) via which the cable 220 is released from the cable housing 230. The cable housing 230 comprises a pulley (not shown) around which the cable 220 is wrapped when located inside the cable housing 230. The pulley is configured to perform a rotational movement when releasing the cable 220 and when collapsing the cable 220. The pulley may move in response to changing a physical position or location of another component in the cuffing device of the subject matter. In some cases, the cable housing 230 is replaceable or removable from the device, for example in order to fix a component placed in the cable housing 230.

The cable 220 is coupled to a pin or to another rigid or semi-rigid connector configured to be secured to the first cuff. The pin may be made of a rigid material such as plastics, metal, and the like. The cable 220 may be placed outside the cable housing 230 also when the cable is fully collapsed in the cable housing 230. The cable housing 230 comprises an external surface 235 having an interface to a cable regulator 240. The external surface 235 may comprise teeth or another shape of protrusions and/or grooves configured to interface with a surface of the cable regulator 240, such that when the cable regulator 240 is closer to the external surface 235 the cable is locked inside the cable housing 230 and when the cable regulator 240 is farther from the external surface 235 the cable can be released from the cable housing 230.

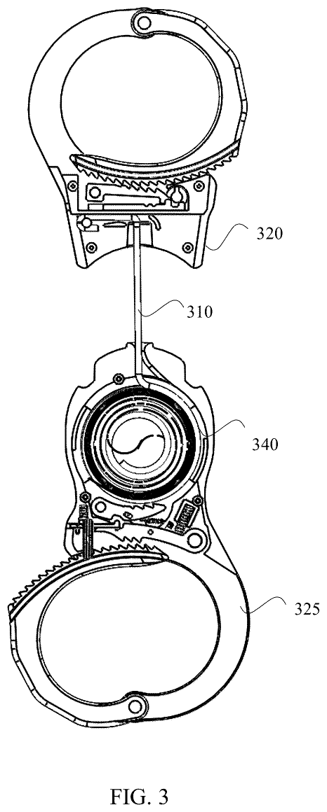

FIG. 3 shows the first cuff distant from the second cuff, connected via cable, according to exemplary embodiments of the subject matter. The first cuff 320 secures the cable inside a cuff member. The cuff member comprises a receiver configured to secure the pin thereto, for example using pins, grooves, and the like, that move in response to movement of the pin inside the cuff member. The cable 310 is rolled inside cable housing 340. The cable housing 340 is secured to the second cuff 325, for example using a set of pins and grooves..

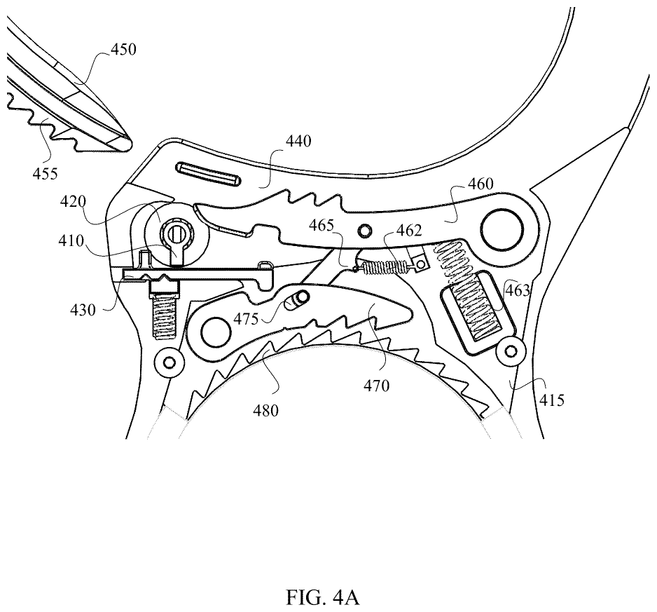

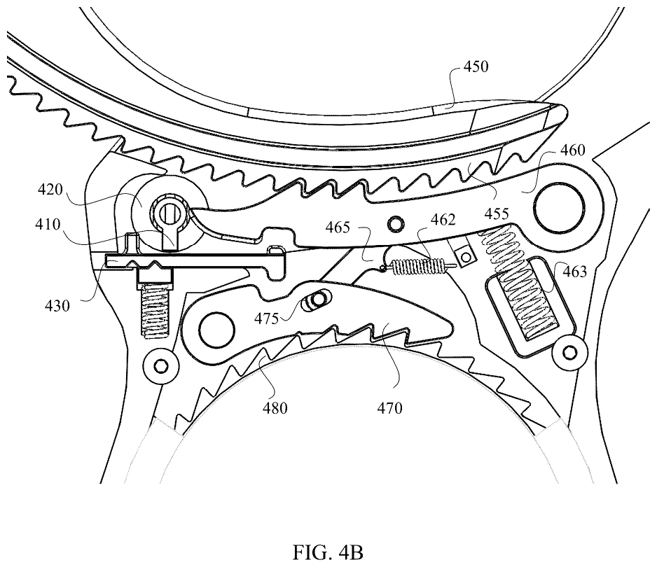

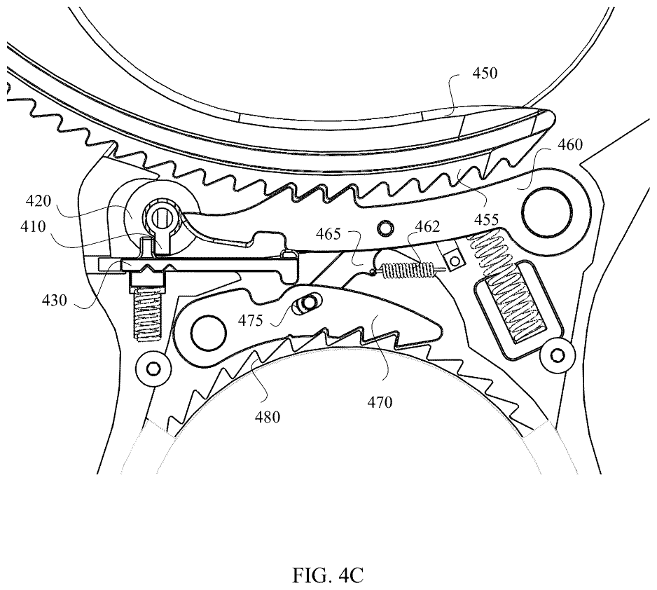

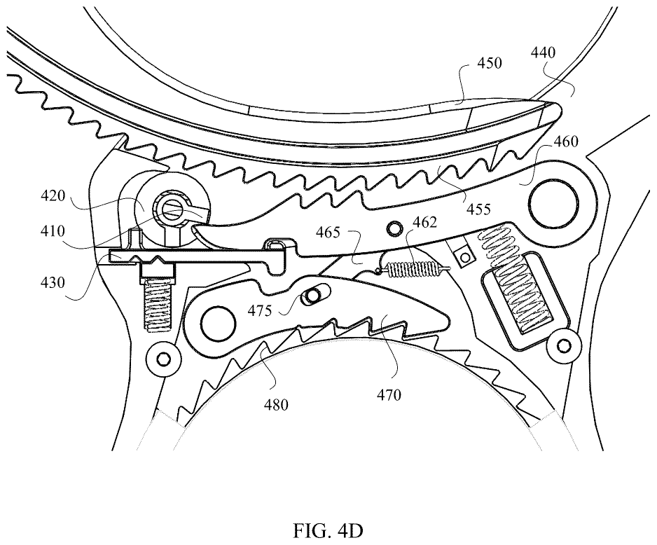

FIGS. 4A-4D show the cuff device in various positions, according to exemplary embodiments of the subject matter. The cuff device comprises a second cuff coupled to the cable regulator. The second cuff comprises a shackle 440 and a locker 450 configured to complete a circle or elliptical shape when the locker 450 is secured to the shackle 440. In some cases, the shackle 440 may comprise an aperture or track configured to interface with the locker 450, for example enabling the locker 450 to slide through. The locker 450 is coupled to a body 415, said body 415 is configured to form a basis for coupling the components of the cuff device, for example, the key house 420, locker slider 460, ratchet locker 470 and ratchet teeth 480.

The second cuff also comprises a key house 420 configured to accommodate a key 410. The key 410 may not be an essential part of the cuff device and may not be part of the scope of protection of the subject matter. The key may be used to unlock the second cuff, for example by enabling the locker 450 to move away from the shackle 440, for example in a clockwise direction. FIG. 4A shows the second cuff in an open state, in which the locker 450 is detached from the shackle 440.

The locker 450 comprises a bottom surface 455 having a shape configured to interface with an upper surface of a locker slider 460. The shape may include teeth, grooves, protrusions and the like. This way, when the locker 450 is inserted into the shackle 440, the bottom surface 455 pushes the locker slider 460 away from the shackle 440. When the locker slider 460 is moved away from the shackle 440, slider spring 463 shrinks. As the slider spring 463 is designed to collapse again, the slider spring 463 is configured to push the locker slider 460 back, towards the shackle 440, when possible. Secondary spring 462 connects the locker slider 460 and connecting rod 465, configured to slide the connecting rod 465 in a groove 475 of the ratchet locker 470.

The locker slider 460 is connected to a ratchet locker 470 via connecting rod 465. For example, when the locker slider 460 moves away from the shackle 440, the ratchet locker 470 is unbale to move away from the shackle 440, toward ratchet teeth 480. In order to move the ratchet locker 470, the following steps are performed—1. Closing the cuff, 2. Approach locker slider 460. 3. Link 465 allows ratchet locker 470 to move. 4. The secondary spring 462 forces the ratchet locker 470 to stick to the 480. At the end of the break, it is indicated that the cable cannot be opened. It is worth noting that the movement of ratchet locker 470 to close the cable is activated against the resistance of the secondary spring 462.

The ratchet locker 470 comprises teeth, or another shape or form, that enables locking the ratchet teeth 480 from moving in a circular manner. When the ratchet teeth 480 are locked and its movement is disabled, the cable cannot be released from the cable housing.

In FIG. 4B, the locker 450 is locked at the shackle 440, and the bottom surface 455 is locked at the upper surface of a locker slider 460.

In FIG. 4C, a locking pin 430 is pushed to prevent movement of both the locker slider 460 and the ratchet locker 470. The locking pin 430 may be accessed by a user of the cuff device, for example in case a proximal end of the locking pin 430 extends out of the housing that covers the components of the second cuff and the cable regulator. When the locking pin 430 is in a locking position, the distal end of the locking pin 430 is in physical contact with the locker slider 460 and the ratchet locker 470. In FIG. 4B the locking pin 430 is in a non-locking position. The locking pin 430 may be moved between the locking position and the non-locking position by turning the key 410 inside the key house 420. In some cases, the locking pin 430 is pushed down with the end of the key similar to other shackles, and no special key is required. Additionally. The mechanism allows the cable 310 to be clamped and locked in the middle of a stroke, which makes it possible to be handcuffed remotely-for example in a hospital.

In FIG. 4D, the key 410 is turned to move the locker slider 460 away from the shackle 440, thereby opening the second cuff. Then, when turning the key 410, the locking pin 430 returns to its original location, pushing the locker slider 460.

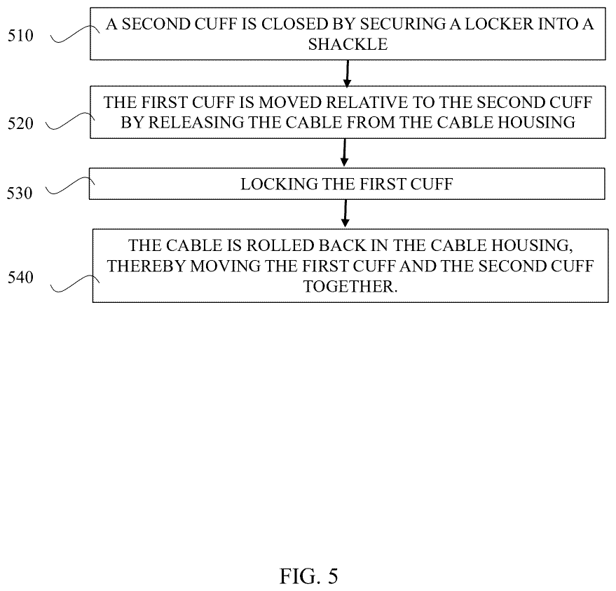

FIG. 5 shows a method of using a cuff device, according to exemplary embodiments of the subject matter.

In step 510, a second cuff is closed by securing a locker into a shackle. The locker may be inserted into an aperture of the shackle, or may be secured to the shackle using a securing mechanism, for example magnets, buttons and the like.

In step 520, the first cuff is moved relative to the second cuff by releasing the cable from the cable housing.

In step 530, lock the first cuff around the person's limb.

In step 540, the cable is rolled back in the cable housing, thereby moving the first cuff and the second cuff together.

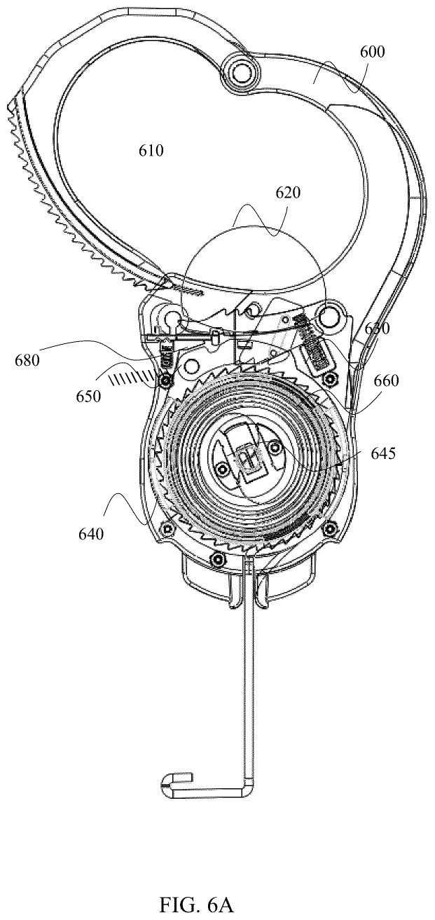

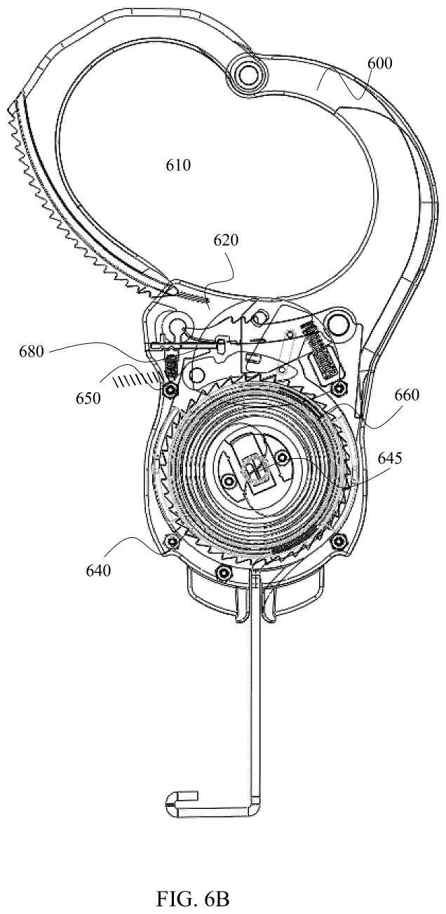

FIGS. 6A-6B show a second cuff member having a movable blocker, according to exemplary embodiments of the subject matter. FIG. 6A shows the movable blocker 620 in a first position blocking presence of a person's hand when the second cuff is closed. FIG. 6A shows the movable blocker 620 in a second position that moves a ratchet locker 650 towards the teeth 660.

The second cuff member comprises a second cuff having a shackle 600. One part of the shackle 600 moves when closing and opening the second cuff. When the shackle 600 is in a closed position, it forms a void 610 that can accommodate a person's arm.

The second cuff member is coupled to a cable regulator configured to regulate rolling and unrolling of a cable 640 connected on a distal end the first cuff member. The cable regulator may be part of the first cuff member, part of the second cuff member or an integral third module of the cuffing system. The cable regulator comprises a body configured to carry or secure at least some of the components described herein. For example, the pulley 645 that regulates the cable's movement is coupled to the body of the cable regulator. In some embodiments, at least some of the cable regulator's components are replaceable, for example the pulley 645.

The cable regulator comprising a movable blocker 620. The movable blocker 620 may be coupled to the cable regulator or to the second cuff member. The movable blocker 620 may have a first position blocking the presence of a person's hand when the second cuff is closed and a second position that moves a ratchet locker 650 towards the teeth 660. The second position limits the pulley to roll in the second direction only. The teeth 660 may be placed on an external surface of the pulley 645. The ratchet locker 650 may be in physical contact with the teeth 660 when the pulley 645 rolls. The pulley 645 may be connected to a proximal end of the cable 640. The pulley 645 may roll in a first direction when the cable 640 is released and rolls in a second direction when the cable 640 is folded.

In some cases, the second cuff member comprising a receiver configured to receive a connector coupled to the first cuff member. In some exemplary embodiments, the connector is connected to the cable, such that the distance between the first cuff and the second cuff is extended when the cable is released. In some cases, the second cuff further comprises a key house configured to accommodate a key configured to open the cuff.

In some cases, the ratchet locker moves in response to movement of the lock. In some cases, the cuffing system further comprising a movable member 680 configured to prevent movement of the ratchet locker 650 away from the teeth 660. When the ratchet locker 650 is pressed against the teeth 660, the pulley 645 cannot move in the first direction and cannot move in the second direction. The movable member 680 may include a narrow-elongated part sliding in a groove of the body and a wide part being in physical contact with the ratchet locker 650. The movable member 680 can move inside the body, away and from the ratchet locker. Movement of the movable member 680 may be initiated by a user of the cuffing system or by a mechanical trigger, such as movement of another component of the cuffing system. In some cases, the cable regulator has a first state in which the pulley cannot rotate, a second state in which the pulley can rotate in the first direction and in the second direction and a third state in which the pulley can rotate in the second direction only. In some cases, the system further comprising a blocker retractor 630 coupled to the movable blocker 620 and configured to push the movable blocker 620 away from the pulley 645. The blocker retractor 630 may include a spring, a piston and similar retracting mechanisms.

Although the invention has been described in conjunction with specific embodiments thereof, it is evident that many alternatives, modifications, and variations will be apparent to those skilled in the art. Accordingly, it is intended to embrace all such alternatives, modifications, and variations that fall within the spirit and broad scope of the appended claims.

All publications, patents, and patent applications mentioned in this specification are herein incorporated in their entirety by reference into the specification, to the same extent as if each individual publication, patent, or patent application was specifically and individually indicated to be incorporated herein by reference. In addition, citation or identification of any reference in this application shall not be construed as an admission that such reference is available as prior art to the invention. To the extent that section headings are used, they should not be construed as necessarily limiting.

1. A cuffing system, comprising:
a first cuff member and a second cuff member;
the first cuff member comprises a first cuff;
the second cuff member comprises a second cuff;
a cable regulator configured to regulate rolling and unrolling of a cable, said cable regulator is connected to at least one of the first cuff member and the second cuff member, said cable regulator comprising:
a body;
a pulley connected to a proximal end of the cable, said pulley rolls in a first direction when the cable is released and rolls in a second direction when the cable is folded;
wherein an external surface of the pulley comprises teeth;
a ratchet locker coupled to the body and being in physical contact with the teeth when the pulley rolls;
a movable blocker coupled to the body or to the second cuff member, said movable blocker having a first position blocking presence of a person's hand in the second cuff when the second cuff is closed and a second position that moves the ratchet locker towards the teeth;
wherein the second position limits the pulley to roll in the second direction only;
a movable member moving in the body and configured to prevent movement of the ratchet locker away from the teeth.

2. The cuffing system of claim 1, further comprising a receiver configured to receive a connector coupled to the first cuff member.

3. The cuffing system of claim 2, wherein the connector is connected to the cable, such that a distance between the first cuff and the second cuff is extended when the cable is released.

4. The cuffing system of claim 1, wherein the second cuff further comprises a key house configured to accommodate a key configured to open the cuff.

5. The cuffing system of claim 1, wherein the second cuff further comprises:
a shackle of a circular shape and a lock configured to be secured to the shackle to lock the second cuff.

6. The cuffing system of claim 1, wherein the movable member comprising a narrow elongated part sliding in a groove of the body and a wide part being in physical contact with the ratchet locker.

7. The cuffing system of claim 1, further comprising a cable housing for storing the cable, wherein the cable housing is removable from the second cuff member.

8. The cuffing system of claim 1, wherein the cable regulator has a first state in which the pulley cannot rotate, a second state in which the pulley can rotate in the first direction and in the second direction and a third state in which the pulley can rotate in the second direction only.

9. The cuffing system of claim 1, further comprising a blocker retractor coupled to the movable blocker and configured to push the movable blocker away from the pulley.
